(19) United States
(12) Patent Application Publication
(10) Pub. No.: US 2019/0136852 A1
(43) Pub. Date: May 9, 2019

(54) Metering Device with a Communication Interface

(71) Applicant: ProMinent GmbH, Heidelberg (DE)

(72) Inventors: Jens Kaibel, Lampertheim-Hofheim (DE); Markus Damnik, Bruhl (DE)

(21) Appl. No.: 16/097,870

(22) PCT Filed: Jul. 14, 2017
(86) PCT No.: PCT/EP2017/067812

§ 371 Date: Oct. 31, 2018

(30) Foreign Application Priority Data
Jul. 18, 2016 (DE) 10 2016 113 214.4

(51) Int. Cl. F04B 49/06; F04B 43/02; F04B 43/04; G01F 11/08; G01F 15/06; G05D 7/06; H04Q 9/00

(52) U.S. Cl. CPC F04B 49/065; F04B 43/02; F04B 43/04; G01F 11/086; H04Q 2209/60; G05D 7/0623; H04Q 9/00; F04B 2201/0201; F04B 2205/00; G01F 15/06

(57) ABSTRACT

The present invention concerns a metering device having a metering chamber in which a displacement element is arrange moveably in such a way that it is reciprocable between two positions, wherein the volume of the metering chamber in the one position is greater than in the other position. The metering device further has an actuator for driving the displacement element, which has an actuator input for an electrical actuation signal and is so constructed that an electrical actuation signal at the actuator input is converted into a mechanical movement. In addition the metering device has a sensor for detecting a physical or chemical measurement value, which has a sensor output for an electrical measurement signal and is so adapted that it detects the physical or chemical measurement value, converts it into an electrical measurement signal and makes same available at the sensor output. Finally the metering device has a communication interface, by way of which the metering device can communicate with a remotely arranged server.

The present invention concerns a metering device having a metering chamber in which a displacement element is arrange moveably in such a way that it is reciprocable between two positions, wherein the volume of the metering chamber in the one position is greater than in the other position.

The metering device further has an actuator for driving the displacement element, which has an actuator input for an electrical actuation signal and is so constructed that an electrical actuation signal at the actuator input is converted into a mechanical movement. In addition the metering device has a sensor for detecting a physical or chemical measurement value, which has a sensor output for an electrical measurement signal and is so adapted that it detects the physical or chemical measurement value, converts it into an electrical measurement signal and makes same available at the sensor output. Finally the metering device has a communication interface, by way of which the metering device can communicate with a remotely arranged server.

Such a metering device can be for example a diaphragm metering pump. Here a moveable diaphragm serves as the displacement element.

In operation the metering chamber is connected to a suction line by way of a suction non-return valve and to a pressure line by way of a pressure non-return valve. Both the suction non-return valve and also the pressure non-return valve can be part of the metering device. They can however also be provided at the installation side.

When therefore the diaphragm is moved into the position in which the volume of the metering chamber is at its largest medium to be conveyed is sucked by way of the suction valve out of the suction line into the metering chamber. Following that the diaphragm is moved in the direction of that position in which the volume of the metering chamber is at its smallest, which thereby provides that the suction non-return valve is closed, whereupon the pressure in the metering chamber rises until the pressure non-return valve opens and the medium to be conveyed, which is in the metering chamber, is urged into the pressure line. A suitable drive actuator is provided so that the diaphragm, that is to say the displacement element, can be reciprocated between the two positions. For example the diaphragm can be driven hydraulically so that the actuator is a corresponding piston of which one face is in contact with the hydraulic fluid.

Alternatively the diaphragm could also be driven magnetically. For example the diaphragm could be fixedly connected to a thrust rod which is mounted in a magnet casing fixedly anchored in the pump housing, moveably axially on the longitudinal axis, so that the thrust rod and therewith the diaphragm upon electrical actuation of the magnetic coil in the magnet casing, is pulled against the action of a compression spring into the bore in the magnet casing and the thrust rod, after deactivation of the magnet, returns to the starting position under the force of the compression spring so that, upon continued activation and deactivation of the magnetic coil, the diaphragm performs an oscillating movement. In that case the magnetic coil is to be viewed as the actuator.

Those metering devices frequently have a sensor for detecting a physical or chemical measurement value. For example it would be possible to detect the pH-value of the medium to be conveyed, in the compression line. Alternatively however the current and/or the voltage through the magnetic coil forming the actuator can also be detected. The sensor detects the corresponding measurement value in operation and converts the detected measurement value into an electrical measurement signal which it makes available at the sensor output. Thus for example the sensor can measure an operating parameter of the metering device (for example current or voltage of the drive, position of the displacement element or pressure in the metering chamber) or an external parameter (for example the pH-value in the pressure or suction line, ambient temperature, air pressure and so forth).

EP 1 757 809 A1 describes a movement-controlled magnetic metering pump. As its sensor, that pump has a position sensor which detects the position of the diaphragm or the thrust rod connected thereto. The magnetic metering pump described therein compares the detected position to a predetermined target value profile and provides for closed-loop control of the movement of the displacement element in such a way that the deviation between the actual position and the target position is as slight as possible.

The known metering device therefore has a suitable control device, by means of which closed-loop-controlled metering can be effected. The corresponding control method in that case is defined in software stored within the metering device. In use of the pump corresponding inputs must be made at the device itself in order to tell the metering device the form in which corresponding closed-loop control is to be effected.

At more or less regular intervals the pump manufacturer develops improved control methods which however cannot be used directly by the metering device. It is therefore in fact necessary for a suitable service technician to carry out on site an update of the software on the metering device by means of a firmware update. With progressive development higher and higher levels of computing and storage capability are made available to the metering devices, with the consequence that older models of the metering devices can no longer be provided with current firmware updates as they no longer comply with the corresponding computing and/or memory requirements. In that case then either it is necessary to dispense with the improved control method or the entire metering device has to be replaced.

Taking the described state of the art as the basic starting point therefore the object of the present invention is to provide a metering device which can be more easily actuated by the user and which irrespective of hardware requirements can be easily adapted to improved control methods.

According to the invention that object is attained in that the actuator, the sensor and the communication interface are so adapted that an electrical measurement signal at the sensor output can be transmitted by way of the communication interface to the remote server and an electrical actuation signal can be received by way of the communication interface and transmitted to the actuator input.

In other words the actual control function is transferred from the metering device to the remote server. Therefore the metering device itself only has to be capable of transmitting the electrical measurement signal at the sensor output to the remote server and receiving a corresponding electrical actuation signal for the actuator input from the remote server.

The communication interface is preferably a network interface, that is to say an interface which permits the sensor and the actuator access to a computer network. In this case the remote server also has to have a corresponding communication interface in the form of a network interface in order also to permit the server access to the computer network.

Thus for example a metering system could include at least one of the metering devices according to the invention and a server arranged remotely from the metering device, with a metering device software, wherein the metering device software implements a closed-loop control device in which the electrical measurement signal transmitted by way of the communication interface is compared to a target value curve, a control variable is calculated therefrom and the control variable is transmitted as an electrical actuation signal to the actuator input by way of the communication interface.

The remotely arranged server does not have to be disposed in the same space or room as the metering device but can be disposed for example in an adjacent room or in any room which has a suitable process control system. Particularly preferably the communication interface is so designed that it can communicate by way of the Internet so that the remote server can be disposed at any desired location, for example at the metering device manufacturer. Particularly in the latter case the metering system can have a plurality of metering devices which all communicate with the remotely arranged server. In a particularly preferred embodiment the sensor has a sensor operational input for an electrical operating signal, wherein there is provided an operating signal generating device which can generate an electrical operating signal and which is connected to the sensor operational input, wherein the operating signal generating device is so adapted that it can communicate by way of the communication interface with a remotely arranged server.

If the sensor is an amperometric sensor like for example a chlorine sensor then for example an activation operation can be started. The manner of activation can depend on various factors like for example the specific situation of use, the nature of the medium to be conveyed, the concentration variation in respect of time or the age of the sensor. By virtue of the fact that the operating signal generating device can communicate with a remotely disposed server the corresponding operating voltage can be determined by the remotely arranged server.

If for example after delivery of the metering device with a corresponding sensor it turns out that after a certain operating time of the sensor the strength of the measurement signal decreases then the activation operation can be triggered to increase the measurement signal, by communication with the remotely arranged sensor.

In a preferred embodiment the sensor can be arranged in the metering chamber. Alternatively the sensor can detect an operating variable of the drive of the displacement element. Operating variables of the actuator can be for example the position of the displacement element or the voltage or the current at the actuator.

In a further particularly preferred embodiment the metering device has a further sensor for detecting a further physical or chemical measurement value, which also has a sensor output for an electrical measurement signal and is so adapted that it detects the further chemical or physical measurement value, converts it into an electrical measurement signal, and makes same available at the sensor output, wherein the further sensor and the communication interface are so adapted that an electrical measurement signal at the sensor output of the further sensor can be transmitted by way of the communication interface to the remotely arranged server.

The metering device software provided on the remotely arranged server therefore provides the information about the value of a further physical or chemical measurement value. That information can be for example integrated in the closed-loop control device. Instead of that or in addition it can also be used for an emergency shutdown or an alarm situation. In a further preferred embodiment there is provided an emergency device which detects whether the metering device is communicating with a remote server by way of the communication interface and, if no communication is detected or if no communication is detected for longer than a predetermined time interval, it initiates an emergency shutdown.

As the metering device according to the invention presupposes a continuous communication with the remote server the emergency device can interrupt the corresponding metering function if for any reason the communication with the remotely disposed server fails.

As an alternative thereto the emergency device could also have a corresponding emergency closed-loop control action. That emergency control action must take place without a communication with the remotely arranged server. For example the emergency control action could transmit a pattern of the electrical actuation signal, that was last received from the remotely arranged server, to the actuator input. If for example the actuator is the magnetic coil of the magnetic drive of a metering pump then in normal operation a time-varying actuation signal (signal pattern) is received from the remotely arranged server and transmitted to the actuator input. In the case of an emergency control situation the last-received, time-varying actuation signal could be further used. Up-to-date adaptation of the signal pattern could admittedly not then occur during the emergency control situation, but in general the interruptions in communication are only of short duration so that, as soon as the communication is restored, the remotely arranged server can resume its function. Alternatively, it would also be possible for a reference stroke frequency to be stored in the metering pump, and in the case of the emergency control situation the metering pump could be operated with the reference stroke frequency. If desired, for the situation where the communication with the remotely arranged server is interrupted for longer than a predetermined period of time, the emergency control action can be terminated and emergency shutdown can be effected.

In a further preferred embodiment the server has a remote access interface, by way of which it is possible to communicate from an external device with the metering device software, wherein preferably the remote access interface is a web interface. Particularly when the remotely arranged server is disposed in an inaccessible server room or even at the manufacturer of the metering device the customer using the metering device can have access to the software by way of the remote access interface and can call up corresponding items of information. Thus for example information about the measured physical or chemical measurement parameters can be displayed on a PC, a smartphone or a tablet computer. In addition the desired metering speed can be adjusted by way of the remote access interface.

In a further preferred embodiment the metering device software has an alarm device capable of sending an alarm signal to an external device. If for example the metering device software on the remotely arranged server establishes that the detected physical or chemical measurement value deviates excessively from the measurement value to be expected, it can appropriately alarm the user of the metering device, for example by sending an SMS or an e-mail or by posting a corresponding Twitter message.

In a further preferred embodiment the server has a data logger which can communicate with the metering device software. All available data concerning the metering device are recorded in the data logger. Thus it is possible to see from the data logger what runtime the metering device has and what operating conditions, like for example metering speed and delivery pressure occurred in the metering application employed.

In a further preferred embodiment the server has a maintenance interface, by way of which it is possible to have access from a maintenance server to the server. For example the content of the data logger can be called up by way of the maintenance server. It is also possible to replace the metering device software or to unlock certain functionalities of the software.

Thus it is possible for example for a metering installation to be provided with a plurality of metering devices which are all connected to a server which is arranged on the premises of the metering installation and on which the metering device software is on file. A corresponding maintenance server can then be arranged at the metering device manufacturer. It is then possible to access a plurality of servers by means of the maintenance server, in which case for example the metering device software can be replaced and/or the content of the data logger can be read out, in which case the servers in turn again control a plurality of metering devices.

Further advantages, features and possible uses of the present invention will be clearly apparent from the description hereinafter of a preferred embodiment. In the drawing:

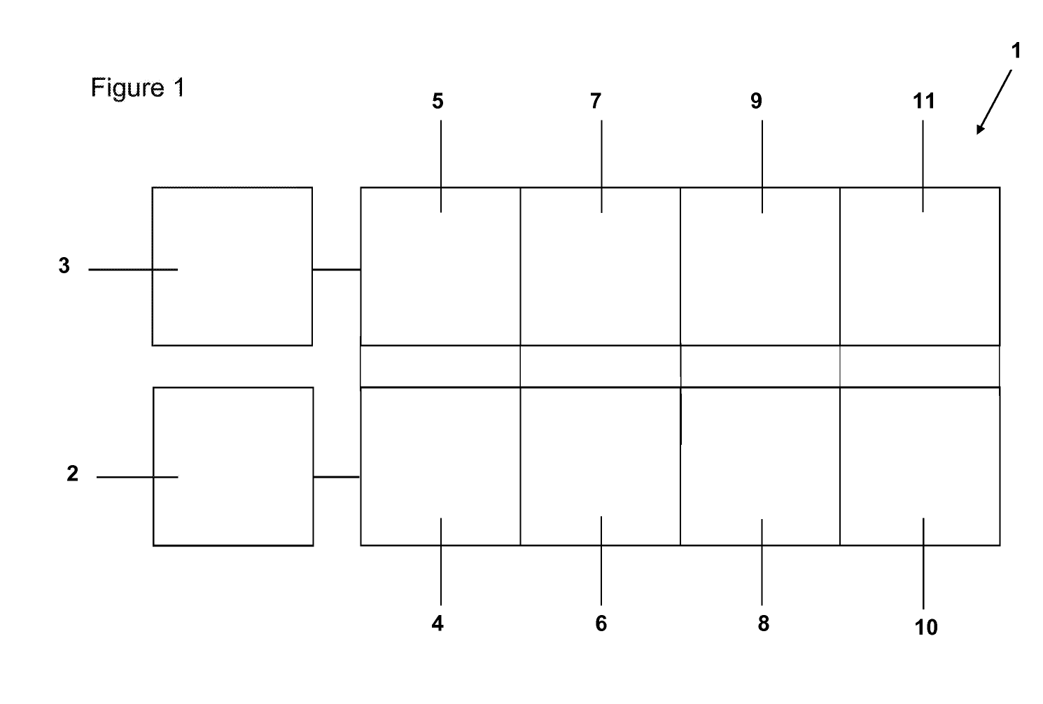

FIG. 1 shows the diagrammatic structure of metering devices in the state of the art, and

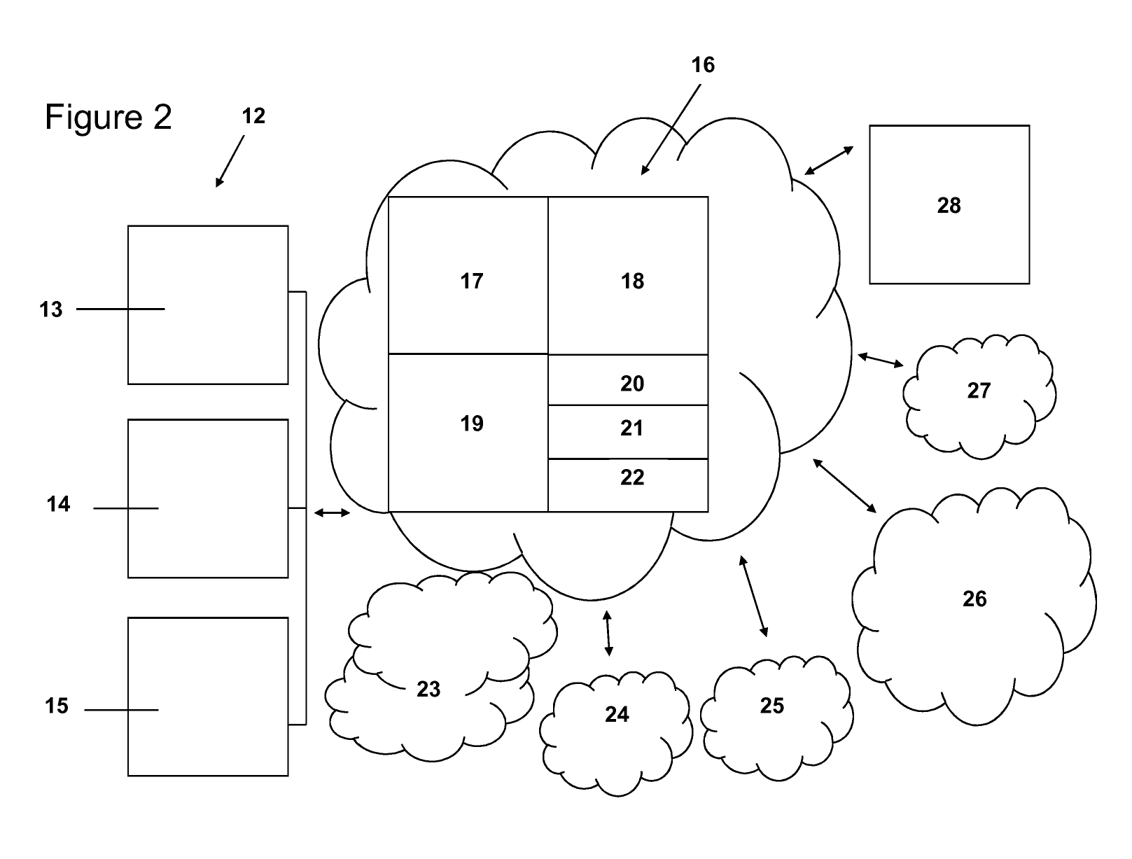

FIG. 2 shows the diagrammatic structure of a metering system having a metering device according to an embodiment of the present invention.

FIG. 1 shows a diagrammatic view of a metering device 1 according to the state of the art. The metering device 1 includes at least one suitable actuator 2, by means of which the displacement element can be driven. In addition there can be one or more sensors 3. For example there can be a sensor for measuring a pH-value. The hardware and software must be provided within the metering device, for implementing the actuator control 4, the sensor data detection 5, the actual closed-loop control function 6, the computing power provision 7, the actuation of other inputs and outputs 8, the sequence control 9, and optionally further functions like for example data logging and data display 10, as well as a suitable user guide 11.

It is immediately apparent that the functionalities 4 to 11 can be modified if required. In that case the corresponding software has to be replaced, which however is not always possible depending on the hardware involved. Therefore in the case of the known metering devices, generally more processing power is afforded than is necessary in order to be prepared for future firmware updates. Nonetheless the expense and effort involved with firmware updating is high and it is not always possible to ensure that the computing power afforded upon manufacture of the metering device is actually also sufficient later.

According to the invention therefore the system shown in FIG. 2 is proposed. Here the metering device 12 according to the invention comprises a sensor 13 and an actuator 14 as well as optionally an emergency control 15. Both the sensor 13 and also the actuator 14 are networkable, that is to say can communicate by way of a communication interface with a server 16 which is arranged remotely. The server which for example can be virtualised is responsible for computing power provision 17, sequence control 18, closed-control loop function 19, it makes a webserver 20 available, it allows software updates 21, and can possibly unlock further functionalities 22 additionally acquired by the customer. The remotely arranged server 16 can include additional Internet services 23, and it can have a connection to a web-SPS system 24, a data logger 25. There can also be a maintenance server 26. Furthermore an alarm means 27 can be provided, and by way of a remote access interface 28 display of data for example by way of a PC, smartphone or a tablet computer.

### LIST OF REFERENCES

1 metering device
2 actuator
3 sensor(s)
4 actuator actuation
5 sensor data detection
6 closed-loop control function
7 computing power provision
8 actuation of other inputs and outputs
9 sequence control
10 data logging and data display
11 user guide
12 metering device
13 sensor
14 actuator
15 emergency control
16 server
17 computing power provision
18 sequence control
19 closed-loop control function
20 webserver
21 software updates
22 further functionalities
23 additional Internet services
24 web-SPS system
25 data logger
26 maintenance server
27 alarm means
28 remote access interface

1. A metering device (1, 12) having a metering chamber in which a displacement element is arranged moveably in such a way that it is reciprocable between two positions, wherein the volume of the metering chamber in the one position is greater than in the other position, wherein the metering device (1, 12) further has:
an actuator (2, 14) for driving the displacement element, which has an actuator input for an electrical actuation signal and is so constructed that an electrical actuation signal at the actuator input is converted into a mechanical movement,
a sensor (3, 13) for detecting a physical or chemical measurement value, which has a sensor output for an electrical measurement signal and is so adapted that it detects the physical or chemical measurement value, converts it into an electrical measurement signal and makes same available at the sensor output,
a communication interface, by way of which the metering device (1, 12) can communicate with a remotely arranged server (16),
characterised in that the actuator (2, 14), the sensor (3, 13) and the communication interface are so adapted that an electrical measurement signal at the sensor output in operation of the metering device (1, 12) can be transmitted by way of the communication interface to the remote server (16) and an electrical actuation signal can be received by way of the communication interface and transmitted to the actuator input.

2. A metering device (1, 12) according to claim 1 characterised in that the sensor (3, 13) has a sensor operational input for the electrical operating signal, wherein there is provided an operating signal generating device which can generate an electrical operating signal and which is connected to the sensor operational input, wherein the operating signal generating device is so adapted that it can communicate by way of the communication interface with a remotely arranged server (16).

3. A metering device (1, 12) according to claim 1 characterised in that there is provided a further sensor (3, 13) for detecting a further physical or chemical measurement value, which has a sensor output for an electrical measurement signal and is so adapted that it detects the further chemical or physical measurement value, converts it into an electrical measurement signal, and makes same available at the sensor output, wherein the further sensor (3, 13) and the communication interface are so adapted that an electrical measurement signal at the sensor output of the further sensor (3, 13) can be transmitted by way of the communication interface to the remotely arranged server (16).

4. A metering device (1, 12) according to claim 1 characterised in that there is provided an emergency device for detecting whether the metering device (1, 12) is communicating by way of the communication interface with a remote server (16) and if no communication or no communication for longer than a predetermined time interval is detected it initiates an emergency shutdown or an emergency closed-loop control action.

5. A metering system comprising at least one metering device (1, 12) according to claim 1 and a remotely arranged server (16) having a metering device software which implements a closed-loop control device in which the electrical measurement signal transmitted by way of the communication interface is compared to a target value curve, a control variable is calculated therefrom and the control variable is transmitted as an electrical actuation signal by way of the communication interface to the actuator input.

6. A metering system according to claim 5 characterised in that the server (16) has a remote access interface, by way of which it is possible to communicate from an external device with the metering device software.

7. A metering system according to claim 5 characterised in that the metering device software has an alarm device capable of sending an alarm message to an external device.

8. A metering system according to claim 5 characterised in that there are provided a multiplicity of metering devices (1, 12);
the metering devices (1, 12) each having a metering chamber in which a displacement element is arranged moveably in such a way that it is reciprocable between two positions, wherein the volume of the metering chamber in the one position is greater than in the other position, wherein the metering device (1, 12) further has:
an actuator (2, 14) for driving the displacement element, which has an actuator input for an electrical actuation signal and is so constructed that an electrical actuation signal at the actuator input is converted into a mechanical movement,
a sensor (3, 13) for detecting a physical or chemical measurement value, which has a sensor output for an electrical measurement signal and is so adapted that it detects the physical or chemical measurement value, converts it into an electrical measurement signal and makes same available at the sensor output,
a communication interface, by way of which the metering device (1, 12) can communicate with a remotely arranged server (16),
characterised in that the actuator (2, 14), the sensor (3, 13) and the communication interface are so adapted that an electrical measurement signal at the sensor output in operation of the metering device (1, 12) can be transmitted by way of the communication interface to the remote server (16) and an electrical actuation signal can be received by way of the communication interface and transmitted to the actuator input.

9. A metering system according to claim 5 characterised in that the server (16) has a data logger which can communicate with the metering device software.

10. A metering system according to claim 5 characterised in that the server (16) has a maintenance interface by way of which it is possible to access the server (16) from a maintenance server (26).

11. A metering installation system having a multiplicity of metering systems according to claim 5 and a maintenance server (26), by way of which the metering device software can be replaced and the content of the data logger can be read out.

12. A metering system according to claim 6 wherein the remote access interface is a web interface.
